(19) United States
(12) Patent Application Publication
(10) Pub. No.: US 2005/0114877 A1
(43) Pub. Date: May 26, 2005

(54) Disc drive

(76) Inventors: Takashi Sato, Tokyo (JP); Hitoshi Furuya, Kanagawa (JP); Shinichiro Ohmura, Kanagawa (JP); Kenichi Furukawa, Kanagawa (JP)

Correspondence Address: PATENTS+TMS;A Professional Corporation, 1914 North Milwaukee Avenue, Chicago, IL, 60647, US

(21) Appl. No.: 10/800,266

(22) Filed: Mar. 12, 2004

(30) Foreign Application Priority Data
Jul. 17, 2003 (JP) 2003-276125

(51) Int. Cl. G11B 33/08; G11B 33/14

(52) U.S. Cl. 720/651

(57) ABSTRACT

A disc drive which can suppress vibration or noise which is generated when an optical disc is rotated by an optical disc rotating mechanism. The disc drive 1 includes a main body 2 having an outer case made from metal plates, a disc tray for loading and ejecting an optical disc in and from the main body 2, a chassis displaceably provided within the main body, an optical disc rotating mechanism having a turntable and displaceable in up and down according to the displacement of the chassis, and a disc damper provided on a top plate 23 of the outer case 24 in a freely rotatable manner so as to hold the optical disc between the turntable and the disc clamper. The outer case 25 is provided with an overlapping portion on at least one of the surfaces of the outer case, and the overlapping portion is formed by superimposing a metal plate onto the surface so that they are joined through a pressure sensitive adhesive layer 10 containing an adhesive or a pressure sensitive adhesive. An area of the overlapping portion 18 occupies more than 15% of a projected area of the surface on which the overlapping portion is provided.

### BACKGROUND OF THE INVENTION

1. Field of the Invention

The present invention is related to a disc drive for at least reproducing data recorded on an optical disc.

2. Description of the Prior Art

There are various disc drives which reproduce data from or record and reproduce data to and from optical discs such as a CD-ROM, CD-R, CD-RW, DVD and the like. These disc drives include a box-shaped main body and a disc tray which is movable with respect to the main body, wherein an optical disc is placed on the disc tray and loaded in the main body by moving the disc tray into the main body. A chassis equipped with an optical disc rotating mechanism which includes a turntable and a spindle motor for rotating the turntable is provided inside the main body so that the front end of the chassis can be pivotally moved or displaced in up and down directions within the main body. Further, a disc clamper is provided on the top plate of the main body in a freely rotatable manner (see Japanese Laid-open Utility Model Publication No. 7-41736).

When an optical disc is loaded in the main body, the chassis is pivotally displaced upwardly together with the turntable, whereby the optical disc is placed on the turntable and then held between the disc damper and the turntable. In this state, the turntable is rotated by the optical disc rotating mechanism, whereby the optical disc is rotated together with the disc clamper.

Now, in this kind of disc drive, there is a problem in that when the optical disc is rotated by the optical disc rotating mechanism, vibration is generated by such rotation and the like, and this creates noise. Further, there is another problem in that such vibration is transmitted to devices disposed in the vicinity of the disc drive to give adverse effects to the devices.

### SUMMARY OF THE INVENTION

It is therefore an object of the present invention to provide a disc drive which can suppress noise and vibration generated when an optical disc is rotated by an optical disc rotating mechanism.

In order to achieve the object, the present invention is directed to a disc drive for at least reproducing data recorded on an optical disc. The disc drive comprises a main body having an outer case made from metal plates; a disc tray which is movable with respect to the main body between a loaded position at which an optical disc is loaded in the main body and an ejected position at which an optical disc can be placed on or removed from the disc tray; a chassis provided within the main body so as to be displaceable; an optical disc rotating mechanism provided on the chassis and having a turntable for rotating the optical disc, the optical disc rotating mechanism being displaceable between a raised position and a lowered position in accordance with the displacement of the chassis; and a disc clamper provided on a top plate of the outer case in a freely rotatable manner, the disc clamper being adapted to hold the optical disc between the disc damper and the turntable when the turntable is displaced to the raised position; wherein the outer case is provided with an overlapping portion on at least one surface thereof, the overlapping portion including another metal plate superimposed onto the metal plate of the surface so that these plates are joined together through a pressure sensitive adhesive layer containing a pressure sensitive adhesive and/or an adhesive, and an area of the overlapping portion occupies more than 15% of a projected area of the surface in which the overlapping portion is provided.

According to the disc drive having the above structure, by providing such an overlapping portion, it is possible to suppress vibration (noise) generated in the outer case 25 when the optical disc is rotated by the optical disc rotating mechanism.

In the present invention, it is preferred that the top plate is formed with a concave disc damper mounting portion having an opening for rotatably mounting the disc clamper, and the outer case is provided with a protecting plate which is superimposed onto the outer surface of the top plate so as to cover the disc damper mounting portion through the pressure sensitive adhesive layer, wherein a portion where the protecting plate and the top plate are joined through the pressure sensitive adhesive layer forms the overlapping portion.

According to this arrangement, the existing member (that is, the protecting plate) can be utilized to form the overlapping portion. Thus, it is not necessary to provide additional member.

Further, in the present invention, it is also preferred that the disc damper mounting portion is formed by depressing the top plate inwardly.

Furthermore, it is also preferred that the pressure sensitive adhesive layer is formed from a double sided pressure sensitive adhesive sheet.

Moreover, it is also preferred that the pressure sensitive adhesive layer includes a base material and a pressure sensitive adhesive agent provided on the both sides of the base material, in which the total thickness of the pressure sensitive adhesive layer is in the range of 0.04 to 0.5 mm.

The above and other objects, structures and advantages of the present invention will be more apparent when the following detailed description of the embodiment is considered in conjunction with the appended drawings.

### BRIEF DESCRIPTION OF THE DRAWINGS

FIG. 1 is a top plan view of an embodiment of a disc drive according to the present invention.

FIG. 2 is a plan view showing the internal structure of the disc drive shown in FIG. 1.

FIG. 3 is a cross-sectional side view of the disc drive shown in FIG. 1.

FIG. 4 is a cross-sectional side view which shows a structure in the vicinity of a disc clamper and a turntable of the disc drive shown in FIG. 1.

FIG. 5 is an enlarged detailed view of the portion [A] shown in FIG. 4.

### DETAILED DESCRIPTION OF THE PREFERRED EMBODIMENTS

The preferred embodiment of the disc drive of the present invention will now be described in detail with reference to the appended drawings.

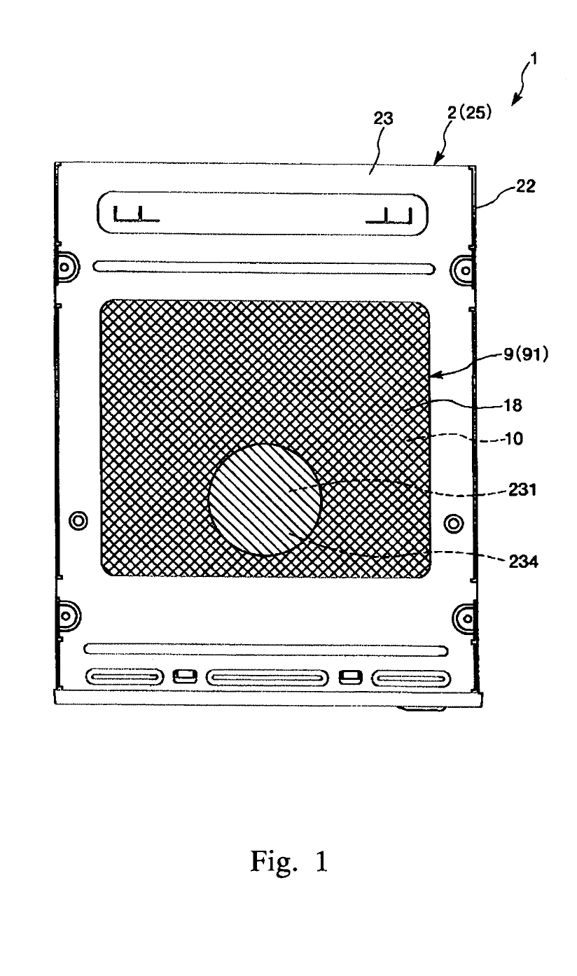

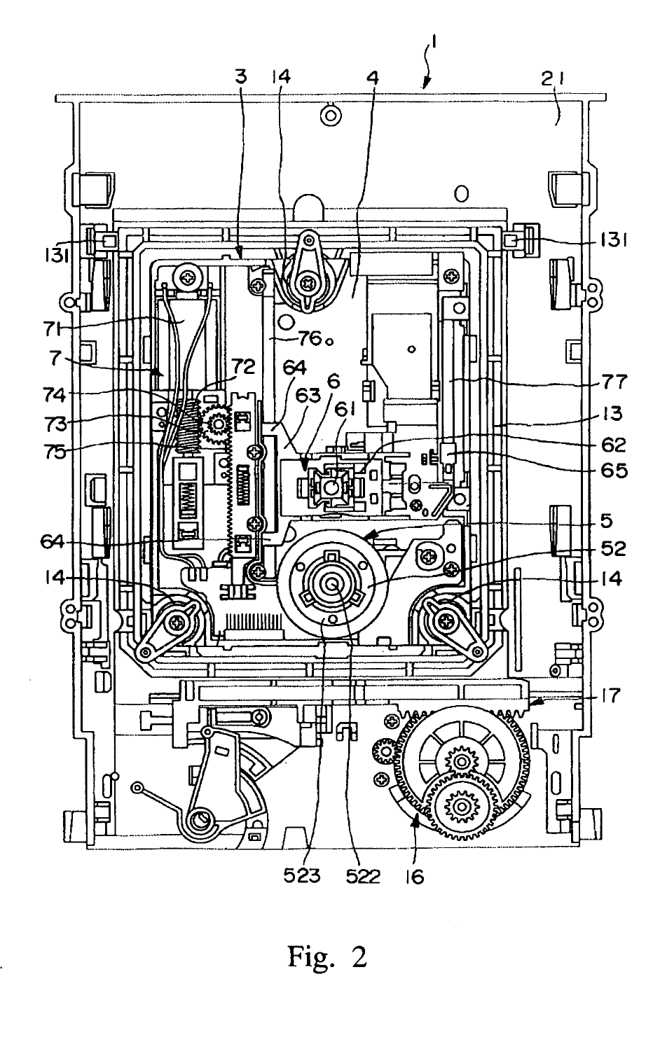

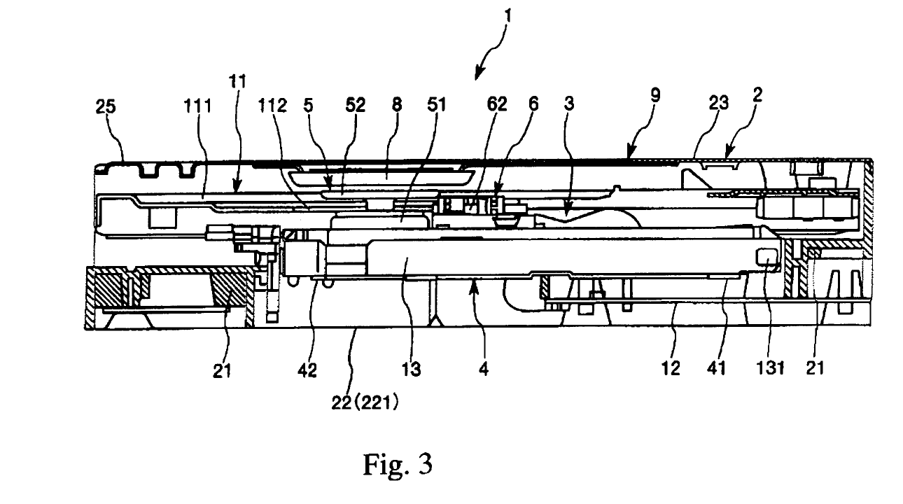

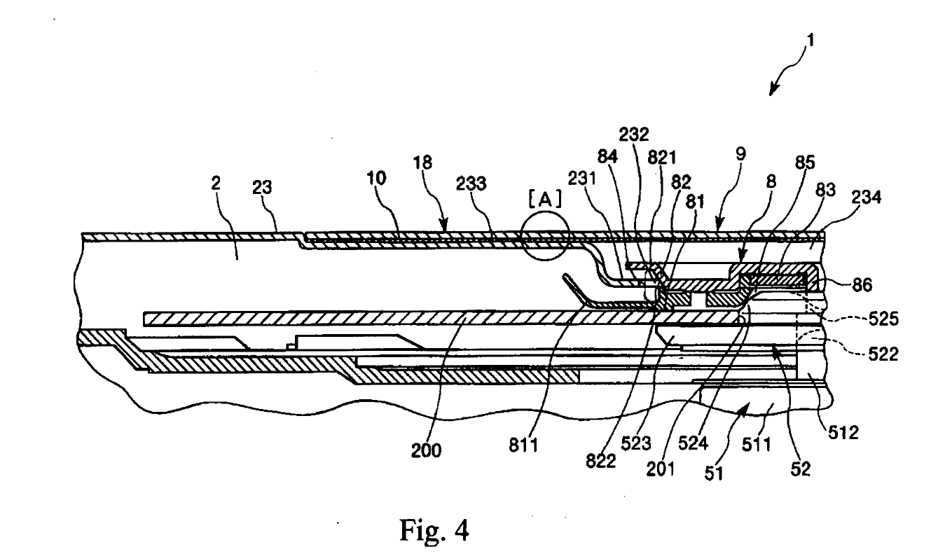

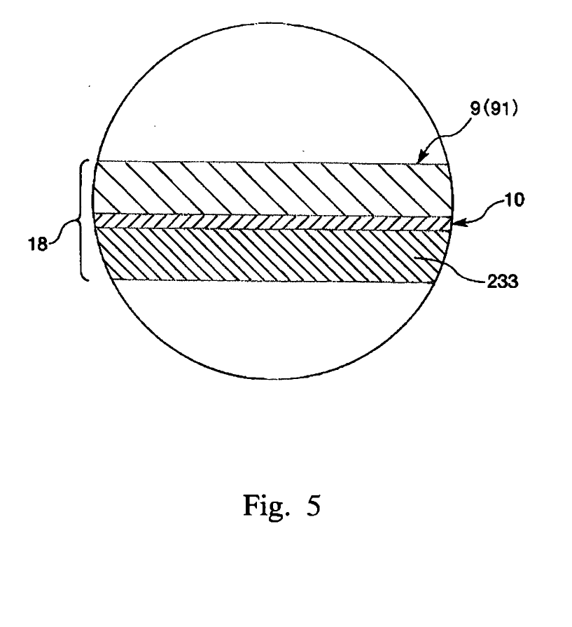

FIG. 1 is a top plan view of an embodiment of a disc drive according to the present invention, FIG. 2 is a plan view showing the internal structure of the disc drive shown in FIG. 1, FIG. 3 is a cross-sectional side view of the disc drive shown in FIG. 1, FIG. 4 is a cross-sectional side view which shows a structure in the vicinity of a disc clamper and a turntable of the disc drive shown in FIG. 1, and FIG. 5 is an enlarged detailed view of the portion [A] shown in FIG. 4. Further, for the sake of convenience, in the following descriptions, unless stated otherwise, the left side in FIG. 3 and FIG. 4 is referred to as the “front”, and the right side as the “back”, and the upper side and the lower side are referred to as the “top” and the “bottom”, respectively.

A disc drive 1 shown in these drawings has a reproducing (play back) function (or recording/reproducing function) which reproduces data recorded on an optical disc 200 such as a music CD, CD-ROM, CD-R, CD-RW, DVD or the like, and it is configured so as to be provided in the body of a computer (not shown in the drawings) such as a personal computer, for example.

As shown in these drawings, the disc drive 1 is equipped with a main body 2 which includes an outer case 25, a disc tray 11 on which an optical disc 200 is to be placed and which is movable in the forward and backward directions with respect to the main body 2, and a mechanism unit 3 provided inside the main body 2. A detailed description of the structure of each element is given below.

As shown in FIG. 1 through FIG. 3, the main body 2 includes a base frame 21 and the outer case 25 which covers the base frame 21.

The outer case 25 includes a casing 22 which covers the bottom and sides of the base frame 21 and a top plate (lid) 23 which covers the top of the base frame 21.

On the base frame 21, there are provided a disc tray moving mechanism 16, the mechanism unit 3 and a main circuit substrate 12 and the like. The disc tray 11 is also movably supported by the base frame 21.

The casing 22 is fixed to the base frame 21 by machine screws, for example, so that the bottom of the base frame 21 is covered with a bottom plate 221 of the casing 22. Further, the top plate 23 is fixed to the top of the base frame 21 by machine screws so that a space for receiving the disc tray 11 is formed between the base frame 21 and the top plate 23.

In this regard, it is to be noted that both the base frame 21 and the disc tray 11 are formed from a resin material. On the other hand, the casing 22 and the top plate 23 described above are formed from plate-shaped members which have been deformed in a prescribed manner by carrying out press forming or the like on metal plates.

A disc damper 8 is provided at a portion of the top plate 23 which faces a turntable 52 (will be described later) in a freely rotatable manner.

The main circuit substrate 12 is formed with a circuit for controlling all operations of the disc drive 1. The main circuit substrate 12 also includes an interface connector for making a connection with the computer, various integrated ICs such as a microprocessor, memories, motor drivers and the like, and various electronic components such as resistors, capacitors, switches and the like. As shown in FIG. 3, the main circuit substrate 12 is provided on the underside of the mechanism unit 3 (chassis 4) described below.

The disc tray 11 has a shallow concave disc holding portion 111, and the optical disc 200 is conveyed in a state where it is placed in the disc holding portion 111.

The disc tray 11 is driven by the disc tray driving mechanism 16 provided on the base frame 21 so as to move (slide) in the forward and backward directions with respect to the main body 2. Namely, the disc tray 11 is movable between a loaded position (the position shown in FIG. 3) at which the optical disc 200 is loaded in the main body 2 (that is, at which the optical disc 200 can be reproduced), and an ejected position (the position shown in FIG. 1) at which the optical disc 200 is ejected (that is, at which the optical disc can be placed on or removed from the disc tray 11). When the disc tray 11 is in the loaded position (hereafter referred to as the “loaded state”), all of the disc tray 11 is housed inside the main body 2. When the disc tray 11 is in the ejected position (hereafter, referred to as the “ejected state”), most of the disc tray 11 protrudes out from the main body 2 in the forward direction.

As shown in FIG. 2, a frame member 13 which supports the mechanism unit 3 is provided inside the main body 2. The frame member 13 has a roughly rectangular frame shape. A pair of protruding shafts 131 are respectively formed on both sides of the rear end portion of the frame member 13. Each of the shafts 131 is supported for pivotal movement in each of receiving portions formed in the base frame 21. In this way, the frame member 13 can pivot around the shafts 131 with respect to the main body 2 (that is, the base frame 21).

When driven by a driving mechanism 17, the frame member 13 is pivotally displaced between a raised position where the frame member 13 forms a posture roughly parallel with the top plate 23 and the bottom plate 221 in the loaded state (see FIG. 3), and a lowered position where the front end is displaced downward to form an inclined posture with respect to the top plate 23 and the bottom plate 221 in the ejected state.

The mechanism unit 3 is positioned inside the frame member 13. The mechanism unit 3 is mainly constructed from a chassis 4, the optical disc rotating mechanism 5, an optical pickup (optical head) 6 and an optical pickup moving mechanism 7.

The chassis 4 is formed to have a roughly plate shape in which a rib (wall portion) is formed on the edge portions thereof. The disc rotating mechanism 5, the optical pickup 6 and the optical pickup moving mechanism 7 are provided (mounted) on the chassis 4.

The chassis 4 is mounted to the frame member 13 via three rubber bushings (elastic members) 14. These rubber bushings 14 make it possible to absorb vibration and shock.

The optical disc rotating mechanism 5 includes a spindle motor 51 and a turntable 52 fixed to a rotor 511 of the spindle motor 51, and is provided at the front side of the chassis 4. The optical disc rotating mechanism 5 rotationally drives the optical disc 200 placed on the turntable 52.

The optical pickup 6 is equipped with an objective lens 61, an actuator 62 which moves the objective lens 61 in the optical axis direction (focusing direction) and the radial direction (tracking direction) of the optical disc 200, a laser light source, a light-converging optical system, a beam splitter (or half mirror), a light-receiving element for receiving the reflected light to produce HF signal, focusing signal and tracking signal and the like, and a pick-up base (support member) 63 which supports these elements, wherein the reflected light of the laser light which has been projected to the recording surface of the optical disc 200 is guided to the light-receiving element via the objective lens, the beam splitter (or half mirror) and the like.

In the loaded state, the objective lens 61 is exposed to the disc holding portion 111 and faces the recording surface of the optical disc 200 through an opening 112 formed in the disc tray 11.

The pick-up base 63 is constructed from a metal material manufactured by die casting, for example. The pick-up base 63 is formed with a pair of sliding portions 64 at the left side thereof in FIG. 2. The sliding portions 64 are formed with holes, respectively, through which a guide shaft 76 is inserted. Further, a sliding portion 65 which engages with and slides on a guide shaft 77 is formed on the right side of the pick-up base 63 in FIG. 2.

The optical pickup moving mechanism 7 is generally constructed from a forward/reverse rotatable sled motor 71, a worm 72 fixed to the rotation shaft of the sled motor 71, a large-diameter gear (worm wheel) 73 which meshes with the worm 72, a small-diameter gear 74 which is fixed to the large-diameter gear 73 to rotate on the same shaft, a rack gear 75 which is fixed to the pick-up base 63 to mesh with the small-diameter gear 74, and the pair of guide shafts 76 and 77 which define a moving path of the pick-up base 63 along which the pick-up base 63 is guided.

When the sled motor 71 is driven, the torque thereof is transmitted sequentially to the worm 72, the large-diameter gear 73, the small-diameter gear 74 and the rack gear 75, whereby the pick-up base 63 is moved along the guide shafts 76, 77 in a radial direction of the optical disc 200 within a prescribed moving range. In this case, depending on the rotational direction of the sled motor 71, the pick-up base 63 moves in a direction approaching the center of rotation of the optical disc 200 or in a direction moving away from the center of rotation.

The chassis 4 (that is, the mechanism unit 3) can be pivotally displaced or rotated with respect to the base frame 21 together with the frame member 13. As shown in FIG. 3, the shafts 131 function as the center of rotation are positioned near the rear end of the chassis 4. Namely, the rear end of the chassis 4 forms the center of rotation, and therefore forms a rotation end 41 which undergoes almost no displacement with respect to the base frame 21, and the front end of the chassis 4 forms a displacement end 42 which is pivotally displaced roughly in the upward and downward directions with respect to the base frame 21.

In accordance with this structure, when the chassis 4 is in the loaded state (at the raised position), the displacement end 42 is raised to form a posture roughly parallel with the top plate 23 and the bottom plate 221 (see FIG. 3), and when the chassis 4 is in the ejection state (at the lowered position), the displacement end 42 is lowered to form an inclined posture with respect to the top plate 23 and the bottom plate 221. In accordance with the displacement of the displacement end 42 of the chassis 4, the optical disc rotating mechanism 5 also moves between the raised position (the position shown in FIG. 3) and the lowered position inside the main body 2.

When the optical disc rotating mechanism 5 is at the lowered position, the turntable 52 is positioned underneath the disc tray 11 so as not to interfere with the disc tray 11 which is moving toward the ejected position.

When the optical disc rotating mechanism 5 is at the raised position, the turntable 52 is protruded (exposed) to the inside of the disc holding portion 111 through the opening 112, and in this way, the optical disc 200 loaded inside the main body 2 is placed on or supported by the turntable 52. In this state, the disc damper 8 is attracted to a magnet (not shown in the drawings) provided in the turntable 52, whereby the optical disc 200 is held between the turntable 52 and the disc damper 8.

Hereinbelow, a detailed description will be made with regard to the structures of the turntable 52 and the disc damper 8.

As shown in FIG. 4, the turntable 52 is fixed to the rotor 511 of the spindle motor 51 in a state that the rotation shaft 512 of the spindle motor 51 is fitted to an aperture 522 which is formed in the center portion of the turn table 52. The rotation shaft 512 is inserted into the aperture 522 so that the shaft 512 reaches the middle part of the aperture 522, whereby the remaining part of the aperture 522 creates a concave portion 525.

The turntable 51 includes a disc-shaped flange portion 523 on which an optical disc 200 is to be placed.

The turntable 53 also has a protruding portion 524 having a substantially truncated cone shape. The protruding portion 524 protrudes from the center portion of the turntable 53. Due to this structure, when the optical disc 200 is placed on the turntable 53 so that the protruding portion is fitted into an opening 201 of the optical disc 200, the optical disc 200 and the turntable 52 are co-centrically positioned with each other.

In the upper portion of the protruding portion 524, a ring-shaped magnet (permanent magnet) is embedded, which is not shown in the drawing. In this connection, it is to be noted that such a magnet may be provided in the disc clamper 8.

A portion of the top plate 23 which faces the turntable 52 is inwardly depressed to form a concave portion. The concave portion serves as a mounting portion 231 for the disc damper 8. The mounting portion 231 is formed with a circular opening 232 in which a cylindrical part of the disc clamper 8 is loosely fitted. The mounting portion 231 also has a disc clamper support surface around the circular opening 232. Further, the depth of the mounting portion is larger than the thickness of the disc clamper 8 so that the disc clamper 8 does not protrude upward above the surface of the top plate 23.

As shown in FIG. 4, the disc clamper 8 is constructed from a substantially disc-shaped first member 81 which is positioned inside the top plate 23 (the mounting portion 231) so as to be able to contact with the optical disc 200, a substantially disc-shaped second member 82 which is provided above the first member 81 and a third member which is held between the first member 81 and the second member 82. Preferably, the first and second members 81 and 82 are formed from a resin material.

In this disc clamper 8, an upper portion of the first member 81 and a lower portion of the second member 82 form a barrel portion 84 having a short cylindrical shape. The diameter of the barrel portion 84 is smaller than the diameter of the opening 232. The disc damper 8 is mounted in the mounting portion 231 in a state that the barrel portion 84 is loosely inserted in the opening 232 so as to have a clearance therearound, so that the disc clamper 8 is freely displaceable in its every radial directions with respect to the top plate 23 (that is, the mounting 231).

The lower portion of the second member 82 which forms a part of the barrel portion 84 is formed into a tapered part 822 of which diameter is gradually decreased toward the disc tray 11, that is, the tapered part 822 converges toward the down direction.

The second member 81 also includes a flange part (engaging part) 821 which extends radially and outwardly from the upper end of the barrel portion 84. The diameter of the flange portion 821 is larger than that of the opening 232 so that the flange portion 821 can not pass through the opening 232. Accordingly, in a state that the turntable 52 is not raised, the flange portion 821 of the disc damper 8 is in abutment with the outer surface of the top plate 23 (that is, the disc damper support surface of the mounting portion 231) around the opening 232 so that the disc damper 8 is supported by the mounting portion 231. In this regards, it is to be noted that the abutment part like the flange portion 821 is not limited to such a structure as described above, and it may be formed into other shape that can not pass through the opening 232. For example, the flange portion 821 may be formed from a plurality of projections arranged in a circumferential direction with predetermined spacings.

The lower end of the first member 81 is formed with a disc-shaped abutment part 811 of which diameter is larger than that of the barrel portion 84. As shown in FIG. 4, when an optical disc 200 is held between the turntable 52 and the disc clamper 8, at least a part of the abutment part 811 is in abutment with the top surface of the optical disc 200. Further, a portion of the abutment part 811 which is close to the outer periphery thereof is bent upwardly to form a skirt form.

As described above, the disc damper 8 is displaceable along the axial direction thereof (that is, in the up and down directions) to the extent of the length of the barrel portion 84.

Further, in the center portion of the lower surface of the disc damper 8, there is formed a concave part 85 having a substantially truncated cone shape. From the center of the bottom of the concave part 85, a positioning boss 86 which is integrally formed with the second member 82 is protruded. Further, a metal member 83 is exposed from the bottom of the concave part 85.

In a state shown in FIG. 4 (hereinafter, referred to as “clamping state”), the protruding portion 524 of the turntable 52 is inserted into the concave part 85 and fitted thereto, and the positioning boss 86 is inserted into the concave part 525 and fitted thereto. In this way, the center of the disc clamper 8 and the center of the turntable 52 is co-centrically aligned. Further, in this clamping state, the disc damper 8s is attracted to the turntable 52 to hold the optical disc 200 therebetween.

Further, in this clamping state, the disc damper 8 is slightly moved upwardly by being lifted by the turntable 52, and thereby the flange part 821 comes away from the disc clamper support surface of the mounting portion 231 of the top plate 23. In the structure shown in the drawing, in this state, the lower end portion of the tapered part is positioned at a height corresponding to the mounting part 231.

Now, as shown in FIG. 1, FIG. 4 and FIG. 5, the outer case 25 of the disc drive 1 of the present invention is provided with an overlapping portion 18 on the top plate 23. In the overlapping portion 18, another metal plate is provided so as to be superimposed on the top plate 23 through a pressure sensitive adhesive layer 10 containing a pressure sensitive adhesive. In this regard, it is to be noted that the cross-hatching portion in FIG. 1 shows the overlapping portion 18 and the hatching portion in FIG. 1 shows a portion where a protecting plate (metal plate) 9 which will be described layer is not joined to the top plate 23 (that is, the concave portion 234). Further, although FIG. 4 shows a structure in which the pressure sensitive adhesive layer 10 is existed in a portion corresponding to the hatching portion in FIG. 1, it is not necessary to provide the pressure sensitive adhesive layer 10 in this portion.

Further, as shown in FIG. 4, in this embodiment, a slightly recessed portion 233 is formed in the top plate 23 around the concave portion 234 thereof. The recessed portion 233 is covered with the protecting plate (metal plate) 9 so that the protecting plate 9 is superimposed onto the outer surface of the top plate 23 (that is, the bottom surface of the recessed portion 2332) through the pressure sensitive adhesive layer 10.

The protecting plate 9 is provided to protect the disc damper 8 by covering a region including the opening 232.

In this embodiment, in order to form the overlapping portion 18, it is not necessary to additionally provide a new separate member, and the overlapping portion can be formed by utilizing an existing member (that is, the protecting plate). Therefore, the number of parts is not increased.

Further, in the present invention, it is preferred that an area of the overlapping portion 18 (that is, an area of the cross-hatched portion) occupies more than 15% of a projected area of the tip plate 23 of the outer case 25 where the overlapping portion 18 is provided. In this regard, it is more preferable that the area of the overlapping portion 18 occupies more than 25% of the projected area, and it is most preferable that the area of the overlapping portion 18 occupies more than 35 to 99% of the projected area. In the embodiment shown in the drawings, the are of the overlapping portion 18 occupies about 41% of the projected area of the surface constituting the top plate 23.

Furthermore, by making the size of the protecting plate 9 larger, the weight of the outer case 25 is increased and the area of the overlapping portion 18 can be made larger, thereby enabling to reduce vibration (noise) more effectively.

Moreover, the pressure sensitive adhesive layer 10 may be formed from a double-sided type pressure sensitive adhesive sheet. By using such a pressure sensitive adhesive sheet, it is possible to easily attach the protecting plate 9 onto the top plate 23 (that is, the recessed portion 233).

By providing such an overlapping portion 18, it is possible to suppress vibration (noise) generated in the outer case 25 when the optical disc 200 is rotated by the optical disc rotating mechanism 5. Namely, when the pressure sensitive adhesive layer 10 receives vibration, it repeats shearing action by flexural vibration, so that vibrational energy is converted into the thermal energy, thereby enabling to suppress such vibration.

For confirming the result of the present invention, the following measurement was carried out for each of the disc drive 1 having the overlapping portion 18 and the disc drive 1 having no overlapping portion 18.

First, an optical disc 200 is loaded in each of the disc drives 1 to rotate the optical disc 200 at a 48× rotation speed by the optical disc driving mechanism 5.

Then, frequencies of the noise generated from each disc drive 1 and sound pressure level corresponding to the frequencies were measured. As a result, it has been found that as compared with the disc drive 1 having no overlapping portion 18, in the disc drive 1 having the overlapping portion 18, the sound pressure level is decreased for 3 to 8 db at each of the low frequency side and the high frequency side with the peak of 9.5 kHz. Namely, it has been confirmed that the vibration (noise) of the outer case 25 can be reduced by the provision of the overlapping portion 18.

Although in the above embodiment, the overlapping portion 18 is provided on the top plate 23 of the outer case 25, the present invention is not limited to such a structure. In the present invention, it is sufficient if the overlapping portion 18 provided in any one of the surfaces of the outer case 25. For example, such an overlapping portion 18 may be provided on the surface of the bottom plate or the surface of the side plate. Even in such an arrangement, it is possible to obtain the same result.

In the foregoing, the present invention was described based on the embodiment of the disc drive shown in the drawings, it goes without saying that the present invention is not limited to the structure of the embodiment. The components and elements constituting the disc drive 1 may be replaced with other components or elements that can exhibit the same functions. Further, arbitral additions may be added thereto.

For example, in the present invention, the pressure sensitive adhesive layer is not limited to one containing a pressure sensitive adhesive. The pressure sensitive adhesive layer may contain an adhesive or both of an adhesive and a pressure sensitive adhesive.

Further, it is preferred that the total thickness of the pressure sensitive adhesive including a base material and a pressure sensitive adhesive agent layer provided on the base material is in the range of 0.04 to 0.5 mm, and more preferably in the range of 0.04 to 0.2 mm.

1. A disc drive for at least reproducing data recorded in an optical disc, comprising:
a main body having an outer case made from metal plates;
a disc tray which is movable with respect to the main body between a loaded position at which an optical disc is loaded in the main body and an ejected position at which an optical disc can be placed on or removed from the disc tray;
a chassis provided within the main body so as to be displaceable;
an optical disc rotating mechanism provided on the chassis and having a turntable for rotating the optical disc, the optical disc rotating mechanism being displaceable between a raised position and a lowered position in accordance with the displacement of the chassis; and
a disc clamper provided on a top plate of the outer case in a freely rotatable manner, the disc clamper being adapted to hold the optical disc between the disc clamper and the turntable when the turntable is displaced to the raised position;
wherein the outer case is provided with an overlapping portion on at least one surface thereof, the overlapping portion including another metal plate superimposed onto the metal plate of the surface so that these plates are joined together through a pressure sensitive adhesive layer containing a pressure sensitive adhesive and/or an adhesive, and an area of the overlapping portion occupies more than 15% of a projected area of the surface in which the overlapping portion is provided.

2. The disc drive as claimed in claim 1, wherein the top plate is formed with a concave disc clamper mounting portion having an opening for rotatably mounting the disc clamper, and the outer case is provided with a protecting plate which is superimposed onto the outer surface of the top plate so as to cover the disc damper mounting portion through the pressure sensitive adhesive layer, wherein a portion where the protecting plate and the top plate are joined through the pressure sensitive adhesive layer forms the overlapping portion.

3. The disc drive as claimed in claim 2, wherein the disc clamper mounting portion is formed by depressing the top plate inwardly.

4. The disc drive as claimed in claim 1, wherein the pressure sensitive adhesive layer is formed from a double sided pressure sensitive adhesive sheet.

5. The disc drive as claimed in claim 1, wherein the pressure sensitive adhesive layer includes a base material and a pressure sensitive adhesive agent provided on the both sides of the base material, in which the total thickness of the pressure sensitive adhesive layer is in the range of 0.04 to 0.5 mm.
